(19) United States
(12) Patent Application Publication
(10) Pub. No.: US 2023/0406701 A1
(43) Pub. Date: Dec. 21, 2023

(54) DIRECT DECOMPOSITION DEVICE AND DIRECT DECOMPOSITION METHOD FOR HYDROCARBON

(71) Applicant: MITSUBISHI HEAVY INDUSTRIES, LTD., Tokyo (JP)

(72) Inventors: Masashi Kiyosawa, Yokohama-shi (JP); Shigeru Nojima, Tokyo (JP); Atsushi Tanaka, Tokyo (JP); Kazuhiro Iwamoto, Tokyo (JP); Takafumi Kubota, Tokyo (JP)

(73) Assignee: MITSUBISHI HEAVY INDUSTRIES, LTD., Tokyo (JP)

(21) Appl. No.: 18/037,416

(22) PCT Filed: Dec. 21, 2021
(86) PCT No.: PCT/JP2021/047174

§ 371 Date: May 17, 2023

(30) Foreign Application Priority Data
Dec. 28, 2020 (JP) 2020-218453
Sep. 21, 2021 (JP) 2021-153622

(51) Int. Cl. C01B 3/30; B01J 23/745; B01J 35/00; B01J 35/02; B01J 35/10; B01J 23/94; B01J 38/00; B01J 8/18; B01J 8/26; B01J 8/00

(52) U.S. Cl. CPC C01B 3/30; B01J 23/745; B01J 35/006; B01J 35/026; B01J 35/023; B01J 35/0053; B01J 35/1038; B01J 35/1042; B01J 35/1009; B01J 35/1014; B01J 23/94; B01J 38/00; B01J 8/1827; B01J 8/26; B01J 8/005; C01B 2203/0277; C01B 2203/0833; C01B 2203/1047; C01B 2203/1235

(57) ABSTRACT

A direct decomposition device for hydrocarbons for directly decomposing hydrocarbons into carbon and hydrogen includes a rector containing a catalyst including a plurality of metal particles with an iron purity of 86% or more. The reactor is configured to be supplied with a raw material gas containing hydrocarbons.

### TECHNICAL FIELD

The present disclosure relates to a direct decomposition device and a direct decomposition method for hydrocarbons.

This application claims the priority of Japanese Patent Application No. 2020-218453 filed on Dec. 28, 2020 and Japanese Patent Application No. 2021-153622 filed on Sep. 21, 2021, the content of which is incorporated herein by reference.

### BACKGROUND ART

Currently, the production of various types of energy relies heavily on fossil fuels such as petroleum, coal, and natural gas, but from the perspective of global environmental protection, the increase in carbon dioxide emissions released from the combustion of fossil fuels has become a problem. The Paris Agreement agreed to in 2015 requires the reduction in carbon dioxide emissions in order to address climate change issues, and the reduction in carbon dioxide emissions from the combustion of fossil fuels is an important problem for thermal power plants and other power plants. While processes to separate and recover emitted carbon dioxide are vigorously studied, technologies to produce energy without emitting carbon dioxide using alternative fuels to fossil fuels are considered.

Therefore, hydrogen, which is clean fuel that does not emit carbon dioxide through combustion, is attracting attention as an alternative fuel to fossil fuels. Hydrogen can be produced, for example, by steam reforming of methane contained in natural gas. However, this production method produces carbon monoxide as a byproduct, which is eventually oxidized and emitted as carbon dioxide. On the other hand, the water electrolysis method and the photocatalytic method are considered as methods to produce hydrogen from water without using fossil fuels, but these methods require large amounts of energy and have economic problems.

Meanwhile, methods have been developed to produce hydrogen and carbon by direct decomposition of methane. The characteristics of direct decomposition of methane are that hydrogen fuel can be obtained without emitting carbon dioxide and that carbon byproduct can be easily immobilized as it is solid, and the carbon itself can be effectively used in a wide range of applications, such as electrode materials, tire materials, and construction materials. Patent Document 1 describes a method for producing hydrogen and carbon by directly decomposing hydrocarbons in the presence of at least one of hydrogen or carbon dioxide, using a supported catalyst with iron as a catalytic component on a support.

### CITATION LIST

### Patent Literature

Patent Document 1: JP4697941B

### SUMMARY

### Problems to be Solved

However, Patent Document 1 discloses the results of sudden drop in activity of reaction that directly decomposes hydrocarbons into carbon and hydrogen within 1 hour, and maintaining the activity of this reaction is a challenge. This sudden drop in activity is thought to be caused by catalyst degradation, where the produced carbon covers the active site of the catalyst. To address this problem, the present inventors have found that the activity of this reaction can be maintained significantly for a longer time by using a catalyst composed of iron particles rather than a supported catalyst with iron on a support. Although it is mentioned in Patent Document 1 that a catalyst consisting of iron alone may be used instead of a supported catalyst, only the study using a supported catalyst is specifically described, and the patentee is not aware that the activity of this reaction can be maintained longer by using a catalyst composed of iron particles.

In view of the above, an object of at least one embodiment of the present disclosure is to provide a direct decomposition device and a direct decomposition method for hydrocarbons whereby it is possible to maintain the activity of the reaction of direct decomposition of hydrocarbons into carbon and hydrogen for a long time.

### Solution to the Problems

To achieve the above object, a direct decomposition device for hydrocarbons according to the present disclosure for directly decomposing hydrocarbons into carbon and hydrogen includes a rector containing a catalyst including a plurality of metal particles with an iron purity of 86% or more. The reactor is configured to be supplied with a raw material gas containing hydrocarbons.

To achieve the above object, a direct decomposition method for hydrocarbons according to the present disclosure for directly decomposing hydrocarbons into carbon and hydrogen includes a step of supplying a raw material gas containing hydrocarbons to a catalyst including a plurality of metal particles with an iron purity of 86% or more.

### Advantageous Effects

With the direct decomposition device and direct decomposition method for hydrocarbons according to the present disclosure, by using a catalyst including a plurality of metal particles with an iron purity of 86% or more as the catalyst for the reaction of direct decomposition of hydrocarbons into carbon and hydrogen, the activity of this reaction can be maintained for a long time since the activity is maintained by developing a new active site even if carbon, a product of this reaction, adheres to the catalyst.

### BRIEF DESCRIPTION OF DRAWINGS

FIG. 1 is a schematic configuration diagram of the direct decomposition device for hydrocarbons according to an embodiment of the present disclosure.

FIG. 2 is a schematic configuration diagram of an experimental device for verifying the effectiveness of the direct decomposition method for hydrocarbons according to an embodiment of the present disclosure.

FIG. 3 is a diagram showing an experiment result of Example 1.

FIG. 4 is a diagram showing an experiment result of Comparative Example 1.

FIG. 5 is a diagram showing an experiment result of Comparative Example 2.

FIG. 6 is photographs of the catalyst before and after the experiment of Example 1.

FIG. 7 is a diagram for describing the mechanism of catalytic action of Example 1.

FIG. 8 is photographs of the surface of catalyst particle in the first stage of the catalytic mechanism of Example 1.

FIG. 9 is photographs of the surface of catalyst particle in the second stage of the catalytic mechanism of Example 1.

FIG. 10 is photographs of the surface of catalyst particle in the fourth stage of the catalytic mechanism of Example 1.

FIG. 11 is the X-ray diffraction patterns of catalyst particle in the first stage and fourth stage of the catalytic mechanism of Example 1.

FIG. 12 is a diagram showing experiment results of Examples 2 to 4.

FIG. 13 is a diagram showing experiment results of Examples 2 to 7.

FIG. 14 is a metallographic phase diagram of carbon steel in equilibrium.

FIG. 15 is a diagram showing experiment results of Examples 8 to 11.

FIG. 16 is a diagram showing an experiment result of Example 12.

FIG. 17 is a diagram showing an experiment result of Example 13.

FIG. 18 is a diagram showing an experiment result of Example 14.

FIG. 19 is a diagram showing an experiment result of Example 15.

FIG. 20 is a diagram showing experiment results of Examples 16 to 23 and Comparative Examples 3 to 5.

FIG. 21 is a diagram showing a relationship between crystallite size and hydrogen production in each of Examples 16 and 19 to 23 and Comparative Example 5.

FIG. 22 is a diagram showing a relationship between specific surface area by BET method and peak value of methane conversion in each of Examples 17, 18, 20 and Comparative Example 5.

FIG. 23 is a diagram showing a relationship between pore specific surface area by mercury injection method and peak value of methane conversion in each of Examples 17, 18, 20 and Comparative Example 5.

FIG. 24 is a diagram showing a relationship between pore volume (mesopores and macropores) and peak value of methane conversion in each of Examples 17, 18, 20 and Comparative Example 5.

### DETAILED DESCRIPTION

Hereinafter, the direct decomposition device and direct decomposition method for hydrocarbons according to embodiments of the present disclosure will be described with reference to the drawings. The following embodiments are illustrative and not intended to limit the present disclosure, and various modifications are possible within the scope of technical ideas of the present disclosure.

### Configuration of Direct Decomposition Device for Hydrocarbons According to Embodiment of Present Disclosure

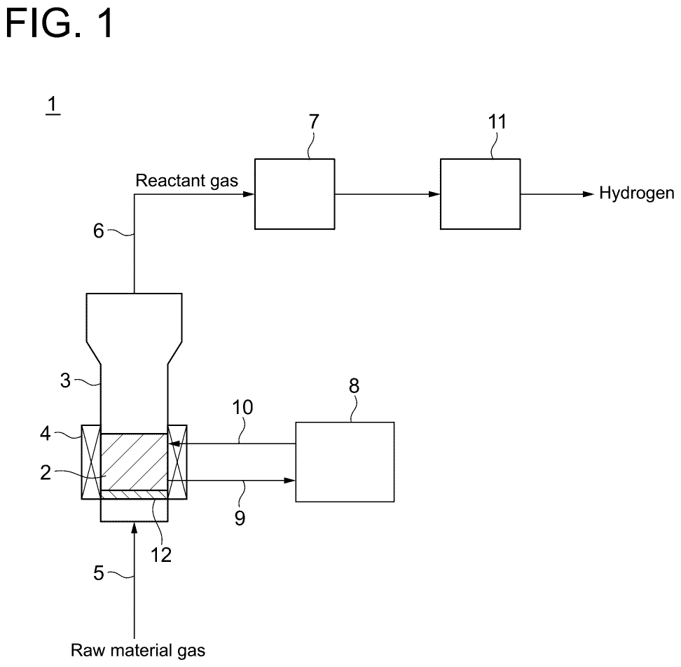

As shown in FIG. 1, a direct decomposition device 1 for hydrocarbons according to an embodiment of the present disclosure includes a reactor 3 containing a catalyst 2 as an essential component. The reactor 3 is provided with a heating device 4 (e.g., a jacket in which steam is circulated) for raising the temperature of the inside of the reactor 3, especially the catalyst 2. The reactor 3 is connected to a raw material supply line 5 for supplying a raw material gas containing only hydrocarbons or a raw material gas containing hydrocarbons and inert gas (nitrogen or noble gas) to the reactor 3, and to a reactant gas flow line 6 through which a reactant gas containing hydrogen produced by reaction of hydrocarbons in the raw material gas by the catalyst 2 flows after flowing out of the reactor 3.

As described below, the catalyst 2 has a configuration with a plurality of particles, and the particles of the catalyst 2 may be in a static state in the reactor 3, or may be in a fluidized bed state where the particles are suspended in the raw material gas by blowing the raw material gas upward. Although carbon produced by the reaction of hydrocarbons in the raw material gas by the catalyst 2 adheres to the particles of the catalyst 2, when the catalyst 2 forms a fluidized bed, the particles of the catalyst 2 rub against each other, and carbon adhering to the particles of the catalyst 2 is physically removed. Therefore, a fluidized bed forming device (plate 12 for supporting the catalyst in the reactor 3 with a plurality of holes through which the raw material gas passes) for forming a fluidized bed of the catalyst 2 constitutes a carbon removal device to remove carbon adhering to the catalyst 2. Since a fluidized bed reactor is one of several reactor types, the adoption of such a reactor allows part of the reactor components to serve as the carbon removal device, eliminating the need for a separate carbon removal device and simplifying the configuration of the direct decomposition device 1 for hydrocarbons.

The direct decomposition device 1 for hydrocarbons may include a catalyst regeneration device 8 disposed outside the reactor 3 as the carbon removal device. The catalyst regeneration device 8 communicates with the reactor 3 via a catalyst supply line 9 for supplying the catalyst 2 from the reactor 3 to the catalyst regeneration device 8 and a catalyst return line 10 for returning the catalyst 2 from the catalyst regeneration device 8 to the reactor 3. The configuration of the catalyst regeneration device 8 is not particularly limited. For example, a rotary pipe (kiln) allowing the particles of the catalyst 2 to rub against each other by agitating the catalyst 2 can be used. As other configurations of the catalyst regeneration device 8, a device that removes carbon from the catalyst 2 by dissolving it, or a device that removes carbon from the catalyst 2 by converting carbon to methane, carbon monoxide, or carbon dioxide by hydrogen, water vapor, and oxygen can be used.

A solid-gas separation device 7 such as a bag filter or a cyclone may be provided in the reactant gas flow line 6. If necessary, depending on the concentration of hydrogen in the reactant gas, a hydrogen purification device 11 may be provided in the reactant gas flow line 6 to purify hydrogen in the reactant gas, or to increase the hydrogen concentration. The configuration of the hydrogen purification device 11 is not particularly limited. For example, a pressure swing adsorption (PSA) device can be used.

### Operation (Direct Decomposition Method) of Direct Decomposition Device for Hydrocarbons According to Embodiment of Present Disclosure

Next, the operation (direct decomposition method) of the direct decomposition device 1 for hydrocarbons according to an embodiment of the present disclosure will be described. The raw material gas entering the reactor 3 via the raw material supply line 5 passes through the catalyst 2. At this time, hydrocarbons in the raw material gas are directly decomposed into hydrogen and carbon (hereinafter, this reaction is referred to as “direct decomposition reaction”). Taking methane as an example of hydrocarbons in the direct decomposition reaction, the reaction represented by the following reaction formula (1) takes place within the reactor 3.

CH₄→2H₂+C (1)

In order to promote the direct decomposition reaction, it is preferable to maintain the temperature of the catalyst 2 within the range between 600° C. to 900° C. by the heating device 4. The technical significance of this temperature range will be described later.

As the specific mechanism of the catalytic action of the catalyst 2 in the direct decomposition reaction will be described later, the produced carbon adheres to the catalyst 2, while the produced hydrogen flows out of the reactor 3 as a reactant gas together with unreacted hydrocarbons (and inert gas) and flows through the reactant gas flow line 6. Recovery of carbon can be performed by recovering the catalyst 2 from the reactor 3 after stopping the supply of the reactant gas to the reactor 3, and, if necessary, removing carbon adhering to the catalyst 2. Recovery of hydrogen can be performed by recovering the reactant gas flowing through the reactant gas flow line 6.

When the catalyst 2 in the reactor 3 forms a fluidized bed, the particles of the catalyst 2 constantly rub against each other, so that carbon adhering to the catalyst 2 is physically removed, and the carbon can be easily recovered. In this case, since fine carbon particles are likely to be entrained in the reactant gas, by providing the solid-gas separation device 7 in the reactant gas flow line 6, fine carbon particles entrained in the reactant gas can be removed and recovered from the reactant gas by the solid-gas separation device 7. Even in the case where the catalyst 2 in the reactor 3 does not form a fluidized bed, part of the produced carbon may be entrained in the reactant gas, so even in this case, the solid-gas separation device 7 may be provided in the reactant gas flow line 6.

In the case where the reactant gas flow line 6 is provided with the hydrogen purification device 11, hydrogen is purified. As a result, when the conversion rate of hydrocarbons is low, the concentration of hydrogen in the reactant gas is low, so the concentration of hydrogen in the final product can be increased by the hydrogen purification device 11.

In the case where the catalyst regeneration device 8 is provided, even while the reactant gas is supplied to the reactor 3, part of the catalyst 2 in the reactor 3 may be supplied to the catalyst regeneration device 8 via the catalyst supply line 9 to remove carbon adhering to the catalyst 2 from the catalyst 2 (regenerate the catalyst 2), and it may be returned to the reactor 3 via the catalyst return line 10. As a result, carbon can be removed from the catalyst 2 to which the produced carbon adheres to regenerate the catalyst 2, and the regenerated catalyst 2 can be reused, so that the operating time of the direct decomposition device 1 for hydrocarbons can be extended. Further, by recovering carbon removed from the catalyst 2 by the catalyst regeneration device 8, carbon can be recovered even while the raw material gas is supplied to the reactor 3. Incidentally, it is not necessary to wholly return the catalyst 2 regenerated by the catalyst regeneration device 8 to the reactor 3; part of the catalyst 2 may be recovered and discarded with recovery of carbon removed from the catalyst 2, and the reactor 3 may be replenished with a new catalyst 2.

### Catalyst Used in Direct Decomposition Device and Direct Decomposition Method for Hydrocarbons of Present Disclosure

The catalyst 2 includes a plurality of iron particles. That is, the catalyst 2 is not a supported catalyst with iron on a support, but an aggregate of iron particles. Each particle of the catalyst 2 is not limited to being formed only of iron, and a certain amount of contamination of components (incidental impurities) that are inevitably mixed into iron and metal elements other than iron are allowed. For this reason, herein the wording “iron particles” means particles made of metal with an iron purity ranging from the lower limit to 100%. The lower limit of iron purity will be described later.

The present inventors have found that the activity of reaction formula (1) can be maintained for a long time by using the catalyst 2 having such a configuration. The effect will be clarified by comparing Example 1 using the catalyst 2 with Comparative Examples 1 and 2 using a supported catalyst. The catalyst used in Example 1 is iron powder (having a particle size of 43 μm or less) available from the Nilaco Corporation. The catalyst used in Comparative Example 1 is a supported catalyst in which iron and molybdenum as active components are supported on a MgO carrier. The iron content is 2.7 mass %, the molybdenum content is 0.3 mass %, and the particle size of the support is about 1 mm. The catalyst used in Comparative Example 2 was obtained by changing the iron content of the catalyst of Comparative Example 1 to 16 mass %.

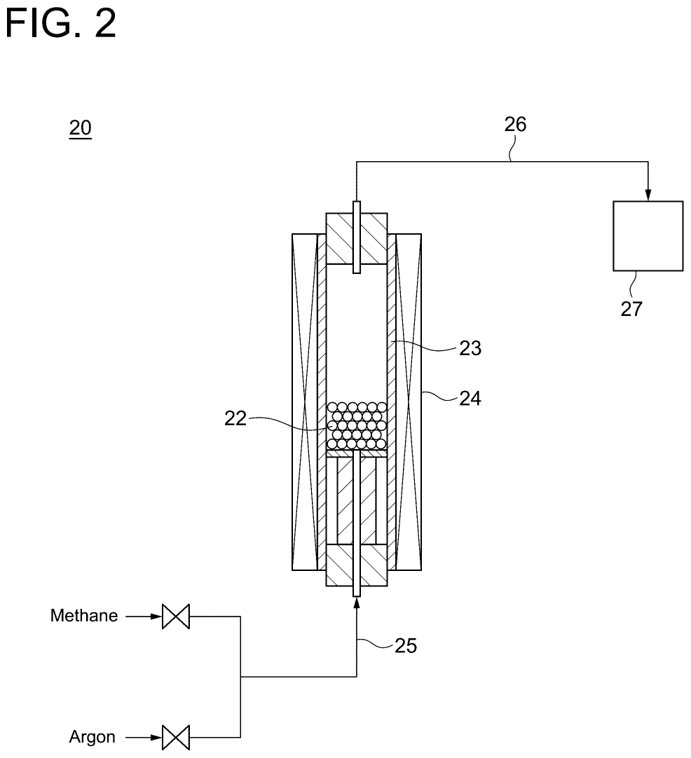

FIG. 2 shows the configuration of an experimental device for comparing Example 1 with Comparative Examples 1 and 2. The experimental device 20 includes a quartz reactor 23 with an inner diameter of 16 mm containing a catalyst 22 of any of Example 1 and Comparative Examples 1 and 2. The reactor 23 can be heated with an electric furnace 24. The reactor 23 is connected to a raw material supply line 25 for supplying methane and argon and to a reactant gas flow line 26 through which a reactant gas containing hydrogen produced by direct decomposition reaction of methane flows after flowing out of the reactor 23. That is, in Example 1 and Comparative Examples 1 and 2, the raw material gas supplied to the reactor 23 is a mixed gas of methane and argon or a gas of methane only. The reactant gas flow line 26 is connected to a gas chromatograph 27 for measuring the composition of the reactant gas. The experimental conditions of Example 1 and Comparative Examples 1 and 2 are summarized in Table 1.

TABLE 1

| | | Comparative | Comparative |
|---|---|---|---|
| Example/Comparative Example | Example 1 | Example 1 | Example 2 |
| Reaction | 900 | 900 | 800 |
| temperature (° C.) | | | |
| Catalyst | 2 | 19 | 10 |
| amount (cc) | | | |
| Height of catalyst | 1.0 | 5 | 5 |
| layer (cm) | | | |
| Flow rate of raw | 100 | 100 | 1000 |
| material gas (cc/min) | | | |
| Space velocity (h⁻¹) | 6000 | 6000 | 6000 |

| | |
|---|---|
| Composition of | Methane: 20 vol %, |
| raw material gas | Argon 80 vol % |

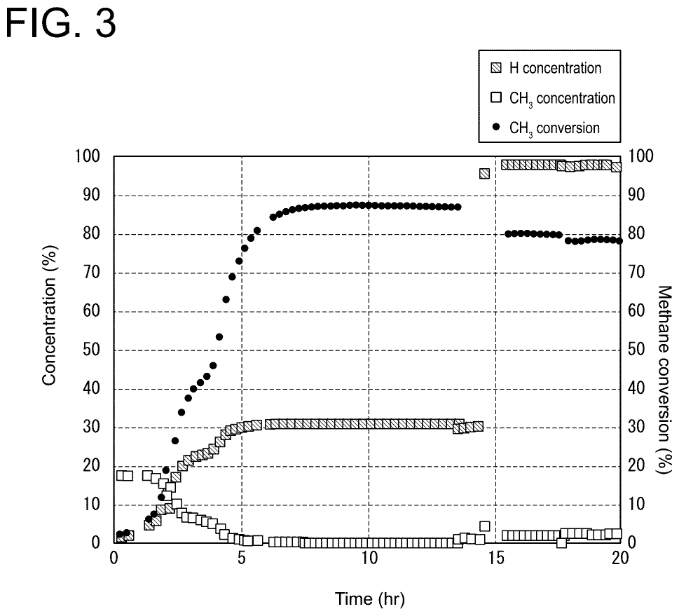

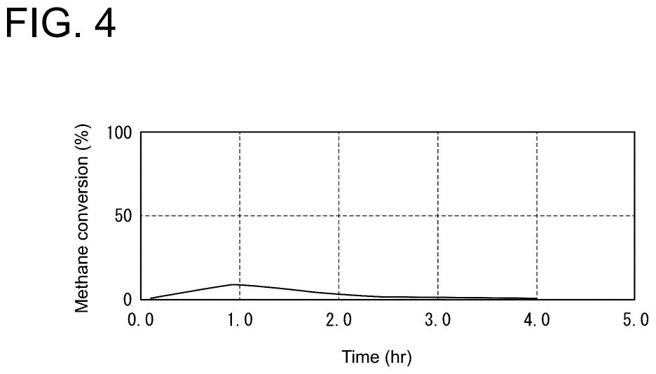

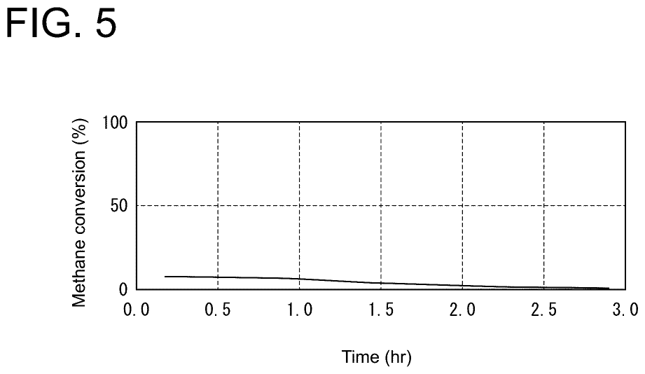

The experiment results of Example 1 and Comparative Examples 1 and 2 are shown in FIGS. 3 to 5, respectively. FIG. 3 shows changes over time in the concentration of methane and hydrogen in the reactant gas and changes over time in the methane conversion. FIGS. 4 and 5 show changes over time in the methane conversion. The methane conversion is defined by the following expression (2). In Comparative Example 1, the methane conversion sharply increased immediately after the start of experiment, and then decreased about 1 hour after the start of experiment. In Comparative Example 2, the methane conversion remained almost constant until about 1 hour after the start of experiment, and then decreased. In contrast, in Example 1, although it took about 7 hours to reach the maximum methane conversion, it remained almost constant until at least 14 hours after the start of experiment. In Example 1, 14 hours after the start of experiment, the supply of argon was stopped and the supply amount of methane was increased to maintain the flow rate of the raw material gas at 100 cc/min so that the composition of the raw material gas was changed to 100% methane. After that, the experiment was terminated 20 hours after the start of experiment. The methane conversion between 14 and 20 hours after the start of experiment was also almost constant.

Conversion=(1−(amount of unreacted methane/amount of methane in raw material))*100 (2)

The results show that the activity of the reaction represented by reaction formula (1) was maintained significantly longer in Example 1 compared to Comparative Examples 1 and 2. Furthermore, under the conditions of Example 1, the methane conversion was close to 90%, resulting in the decomposition of the majority of the supplied methane. This is the same even when the composition of the raw material gas (methane content in the raw material gas) is changed.

The amount of hydrogen obtained from the start of the experiment to when the methane conversion drops to 1/10 of the maximum value, expressed as the amount per unit catalyst amount, was 100 (cc-hydrogen/cc-catalyst) in Comparative Example 1 and 200 (cc-hydrogen/cc-catalyst) in Comparative Example 2, whereas the amount of hydrogen obtained from the start of the experiment to the end of the experiment, expressed as the amount per unit catalyst amount, was 2000 (cc-hydrogen/cc-catalyst) in Example 1, which indicates that the amount of hydrogen as a product of the reaction represented by reaction formula (1) is significantly increased.

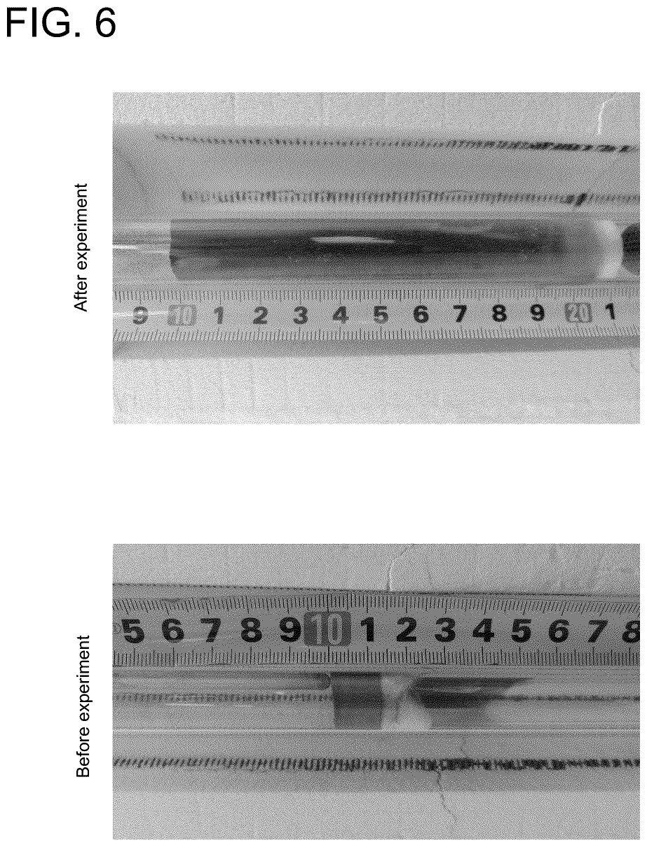

FIG. 6 shows photographs of the catalyst before and after the experiment of Example 1. The height of the catalyst layer was 1.0 cm before the experiment, whereas the height of the catalyst layer after the experiment was increased to about 10.5 cm. This is due to the increase in bulk by carbon, a product of the reaction represented by reaction formula (1), adhering to the catalyst, which suggests that carbon was also produced in an amount corresponding to the produced hydrogen.

From these experimental results, the present inventors believe that the catalyst in Example 1 functions by a different mechanism from the conventionally supported catalyst used in Comparative Examples 1 and 2. Specifically, the catalytic action of the conventional supported catalyst occurs immediately after the start of the experiment, but the activity is reduced at an early stage because the produced carbon covers the active site of the catalyst, preventing methane from reaching the active site. In contrast, in the case where the catalyst composed of iron powder is used as in Example 1, even if the produced carbon adheres to the surface of the iron powder as in Comparative Examples 1 and 2, the activity may be maintained by developing a new active site. The mechanism of the catalytic action in Example 1 will be described in detail below.

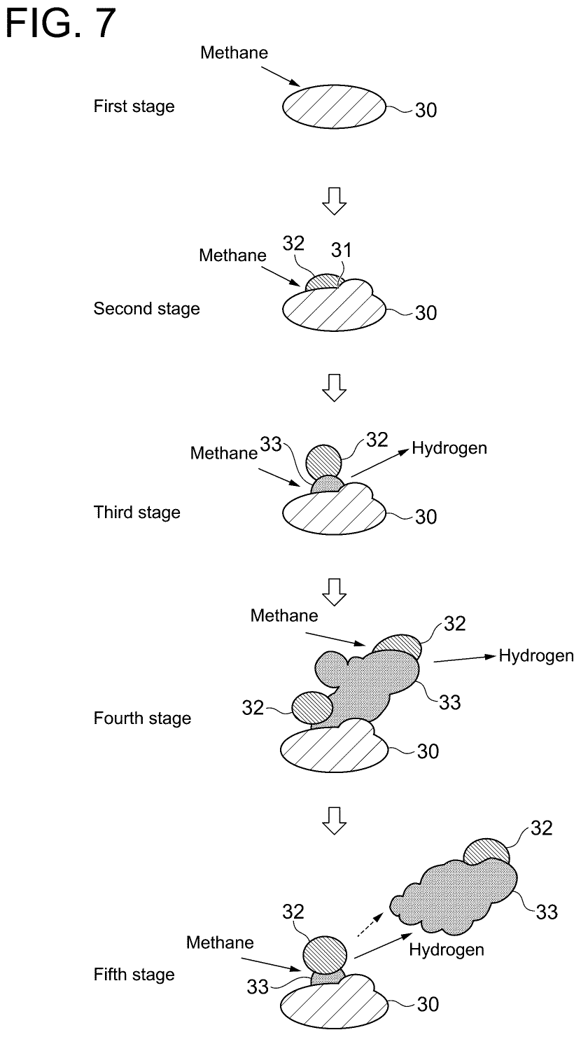

As shown in FIG. 7, in the first stage when methane begins to reach a catalyst particle 30, the activity of the catalyst is very low, so the reaction rate of the reaction represented by reaction formula (1) is very slow. Gradually, however, this reaction begins to occur and hydrogen and carbon begin to form. In the subsequent second stage, a grain boundary 31 is formed in the catalyst particle 30 by hydrogen attack. Starting from this grain boundary 31, iron fine particles migrate from the catalyst particle 30 and react with the produced carbon to form iron carbide 32. This iron carbide 32 serves as the active site of the catalyst. The gradual increase in the number of such active sites in the catalyst particle 30 increases the activity of the reaction represented by reaction formula (1).

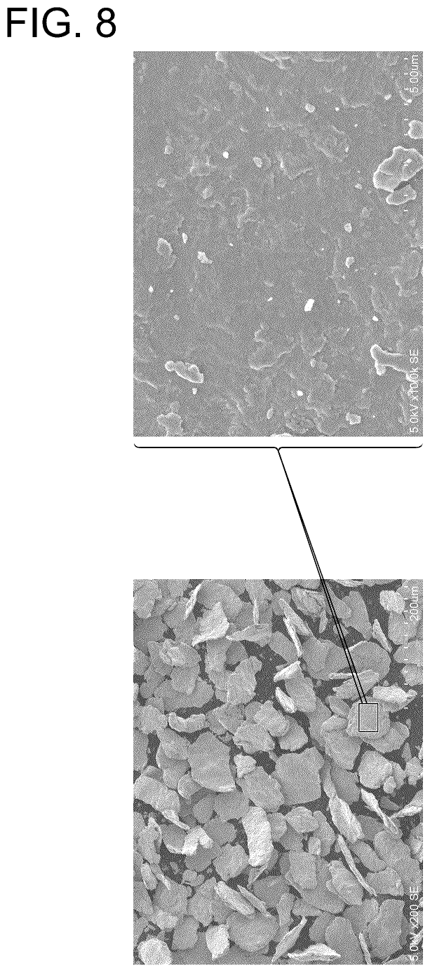

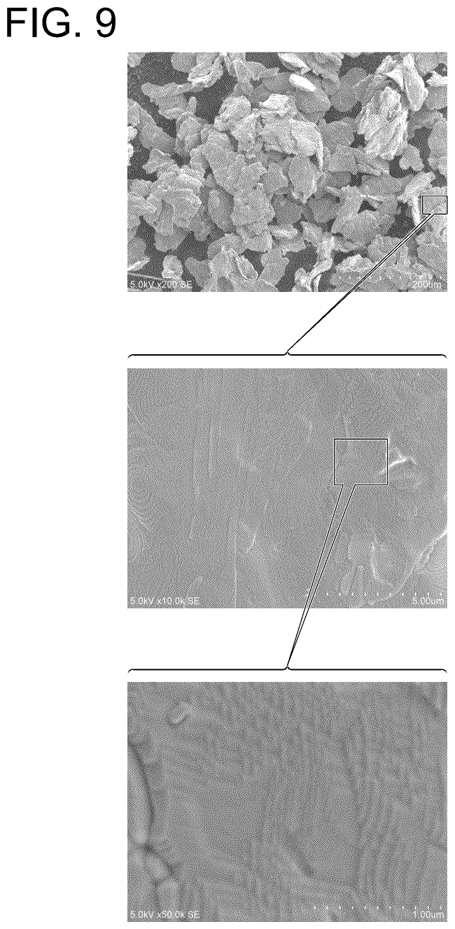

To verify the above description of the first to second stages, photographs of the surface of the catalyst particle 30 in each of the first and second stages were taken and are shown in FIGS. 8 and 9, respectively. In the first stage, as shown in FIG. 8, no fine particles of iron are observed on the catalyst particle and the smooth surface characteristic of austenite is observed. In contrast, in the second stage, as shown in FIG. 9, submicron stripes can be seen on the catalyst particle. This indicates that the carbidation of iron progresses with hydrogen attack, and the iron is split into submicron iron particles to form the precursor of the active site.

As shown in FIG. 7, in the third stage following the second stage, methane is adsorbed on iron carbide 32, which is the active site, the methane is decomposed into hydrogen and carbon, and carbon 33 is deposited between the iron carbide 32 and the catalyst particle 30. In the subsequent fourth stage, as methane is adsorbed on the iron carbide 32 and decomposed into hydrogen and carbon, the carbon is deposited between the iron carbide 32 and the deposited carbon. In this way, carbon 33 grows to extend from the catalyst particle 30. Since the iron carbide 32 will be at the top of the growing carbon (the end away from the catalyst particle 30), there is little inhibitory effect of carbon 33 on methane reaching the iron carbide 32.

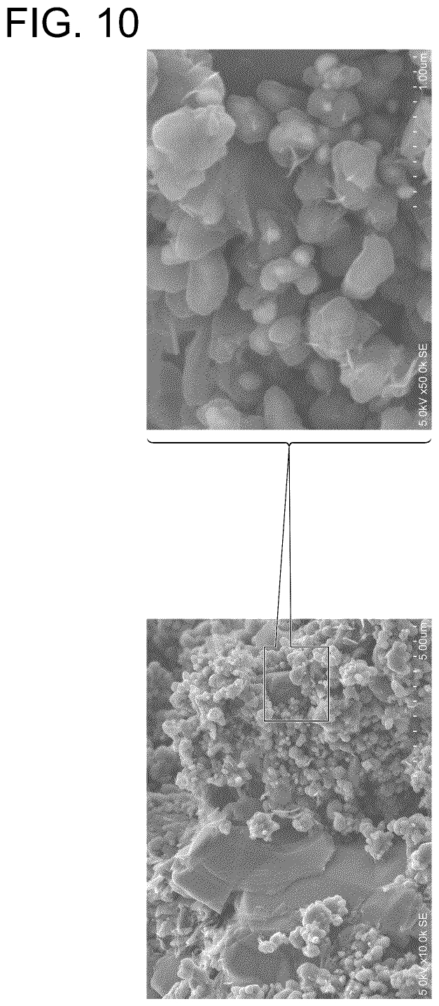

To verify the above description of the third to fourth stages, photographs of the surface of the catalyst particle 30 in fourth stage were taken and are shown in FIG. 10. In the fourth stage, carbon is deposited on the surface of submicron iron particles to form a core-shell structure. These submicron iron particles are considered to be iron carbide (cementite (Fe₃C)/martensite (Fe_{1.88}C_{0.12})) as the active site. Carbon surrounding the iron carbide is considered to function as a support of the active site, which also contributes to the stabilization and high performance of the active site.

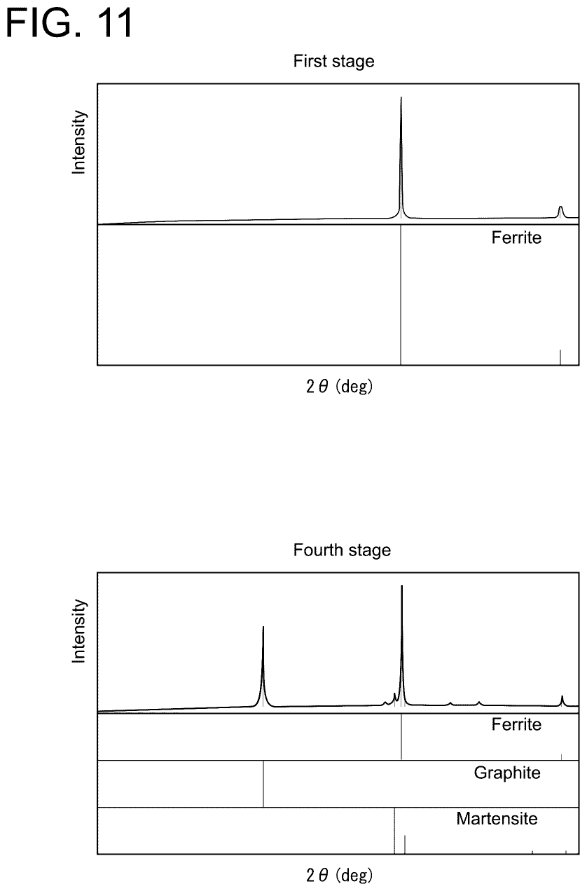

FIG. 11 shows the X-ray diffraction patterns of the catalyst particle 30 in the first stage and the catalyst particle 30 in the fourth stage. In the first stage, only the α-Fe (ferrite) peak of single iron forming the catalyst particle 30 is observed, whereas in the fourth stage, not only the α-Fe (ferrite) peak but also the graphite and martensite (Fe_{1.88}C_{0.12}) peaks are observed. This result also confirms the presence of iron carbide and verifies that the active site is submicron iron particles (iron carbide). The fact that only martensite peak and no cementite peak are observed in the X-ray diffraction pattern of the fourth stage may be due to the rapid cooling of the catalyst particle 30 to room temperature when the X-ray diffraction pattern was taken.

As shown in FIG. 7, the fifth stage does not necessarily occur after the fourth stage, but in the fifth stage, carbon 33 is removed from the catalyst particle 30 either naturally or by the action of physical forces. Then, the iron carbide 32 as the active site is eliminated from the catalyst particle 30, but since iron carbide 32 continuously appears from the catalyst particle 30, no rapid decrease in active sites occurs.

This mechanism from the first to fourth (and possibly the fifth) stages fully explains the characteristics of the experimental result in Example 1, namely, that the activity of the reaction slowly increased by 5 hours after the start of experiment and that the activity of the reaction was stable for a long time thereafter.

Thus, by using a catalyst including a plurality of iron particles as the catalyst for the direction decomposition reaction, the activity of the direction decomposition reaction can be maintained for a long time since the activity is maintained by developing a new active site even if carbon, a product of the direction decomposition reaction, adheres to the catalyst.

### Examination of Various Factors Given to Direct Decomposition Device and Direct Decomposition Method for Hydrocarbons of Present Disclosure

### [Reaction Temperature]

Next, experiments of Examples 2 to 4 were conducted using the experimental device 20 shown in FIG. 2 to examine the effect of reaction temperature on the direct decomposition device 1 and direct decomposition method for hydrocarbons of the present disclosure. The experimental conditions of Examples 2 to 4 are summarized in Table 2. The catalyst used in Examples 2 to 4 is the same as the catalyst used in Example 1.

TABLE 2

| Example | 2 | 3 | 4 |
|---|---|---|---|
| Reaction | 900 | 800 | 750 |
| temperature (° C.) | | | |
| Catalyst | 0.2 | 0.2 | 0.2 |
| amount (cc) | | | |
| Height of catalyst | 0.1 | 0.1 | 0.1 |
| layer (cm) | | | |
| Flow rate of raw | 20 | 20 | 20 |
| material gas (cc/min) | | | |
| Space velocity (h⁻¹) | 6000 | 6000 | 6000 |

| | |
|---|---|
| Composition of | Methane: 100 vol % |
| raw material gas | |

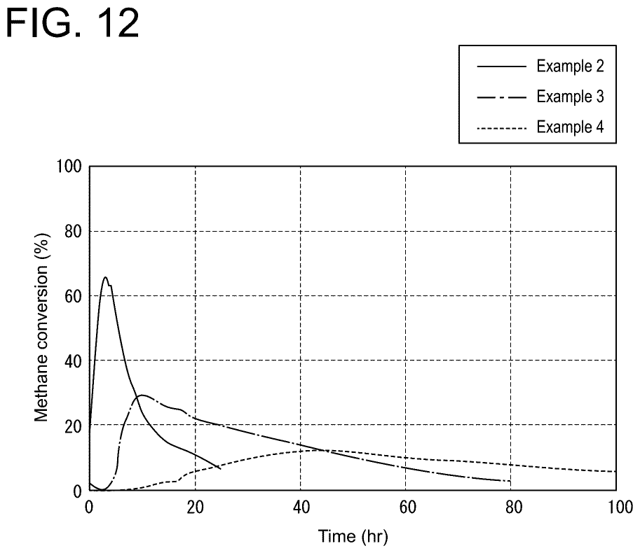

The experiment results of Examples 2 to 4 are shown in FIG. 12. FIG. 12 shows changes over time in the methane conversion. According to the magnitude relationship between the methane conversions in Examples 2 to 4, the higher the reaction temperature, the higher the peak value of methane conversion, and the shorter the time to reach the peak value.

In Examples 2 and 3, the methane conversion reached its maximum value up to 20 hours after the start of experiment and then began to decrease, whereas in Example 4, the methane conversion increased very slowly up to 40 hours after the start of experiment and then began to decrease very slowly. In Example 4, the lower reaction temperature may have slowed down the catalytic action, especially the above-described mechanism up to the second stage, resulting in a lower maximum value of methane conversion.

However, the amount of hydrogen obtained from the start of the experiment to when the methane conversion drops to 1/10 of the maximum value, expressed as the amount per unit catalyst amount, was 75000 (cc-hydrogen/cc-catalyst) and 120000 (cc-hydrogen/cc-catalyst) in Examples 2 and 3, and the amount of hydrogen obtained during 200 hours from the start of experiment, expressed as the amount per unit catalyst amount, was 150000 (cc-hydrogen/cc-catalyst) in Example 4. These results show a significant increase in the production amount of hydrogen compared to Comparative Examples 1 and 2, where the conventional supported catalyst was used, and it can thus be assumed that the above-described catalytic mechanism is also applied under the conditions of Examples 2 to 4. Further, the experimental results of Examples 2 to 4 show that the activity of the direct decomposition reaction can be maintained for a long time when the reaction temperature is between 750° C. and 900° C.

From the experimental results of Examples 2 to 4, it was confirmed that the activity of the direct decomposition reaction can be maintained for a long time when the reaction temperature is between 750° C. and 900° C. Next, experiments of Examples 5 to 7 were conducted to examine whether the activity of the direct decomposition reaction can be maintained for a long time at a reaction temperature less than 750° C. The reaction temperatures of Examples 5 to 7 are summarized in Table 3. The conditions other than the reaction temperature in Examples 5 to 7 are the same as those in Examples 2 to 4, and the catalyst used in Examples 5 to 7 is the same as the catalyst used in Examples 1 to 4.

TABLE 3

| Example | 5 | 6 | 7 |
|---|---|---|---|
| Reaction | 700 | 650 | 600 |
| temperature (° C.) | | | |

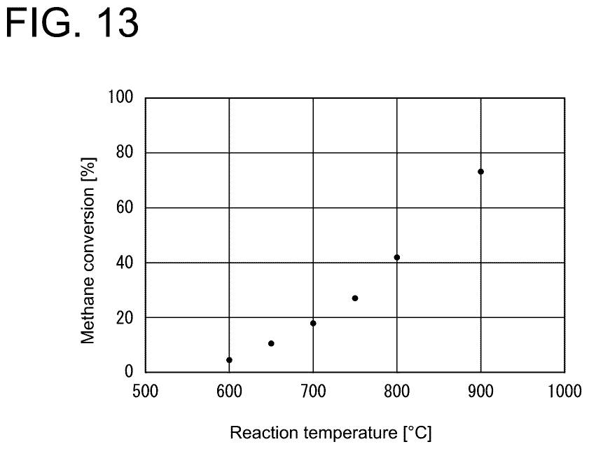

In Examples 2 to 4, the methane conversion increased after the start of experiment and showed a decreasing behavior after the methane conversion reached its peak. Although the methane conversion of Examples 5 to 7 did not show changes over time, the same behavior was observed in Examples 5 to 7. In other words, there was a peak value of methane conversion in each of Examples 2 to 7. FIG. 13 shows a relationship between reaction temperature and peak value of methane conversion in Examples 2 to 7.

FIG. 13 shows that in the reaction temperature range between 600° C. and 900° C., the peak value of methane conversion decreases as the reaction temperature decreases. However, even at a reaction temperature of 600° C., the peak value of methane conversion is maintained at about 5%. Since the catalyst used in Examples 1 to 4 has been shown to maintain the activity of the direct decomposition reaction significantly longer, the activity of the direct decomposition reaction should also be maintained longer in Examples 5 to 7. Then, even if the peak value of methane conversion in Examples 5 to 7 is about 5% to less than 20%, the sustained activity of the direct decomposition reaction is expected to produce more hydrogen and carbon than in Comparative Examples 1 and 2.

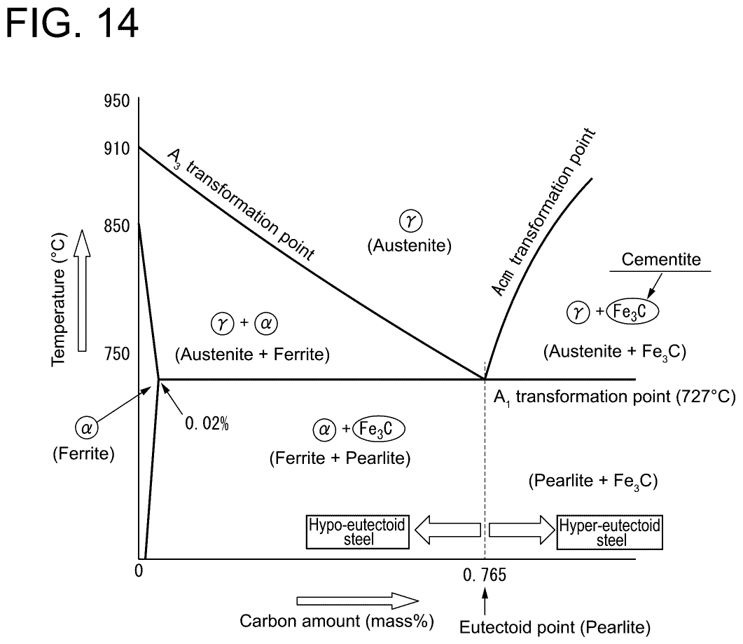

FIG. 14 shows a metallographic phase diagram of carbon steel in equilibrium (cited from https://www.monotaro.com/s/pages/readingseries/kikaibuhinhyomensyori_0105/). According to this, the iron phase changes to γ-Fe (austenite) above 727° C. Therefore, it is considered that during the reaction represented by reaction formula (1), iron in the catalyst is in an austenitic state and reacts with methane in the raw material gas to form iron carbide, which becomes the active site to develop a new active site. From the theoretical consideration based on the metal composition phase diagram, it is understood that the above-described effect can be obtained at a reaction temperature of 727° C. or higher.

[Methane Partial Pressure]

Next, experiments of Examples 8 to 11 were conducted using the experimental device 20 shown in FIG. 2 to examine the effect of partial pressure of methane on the direct decomposition device 1 and direct decomposition method for hydrocarbons of the present disclosure. The experimental conditions of Examples 8 to 11 are summarized in Table 4. The reaction temperature, catalyst amount, catalyst layer height, flow rate of raw material gas, and space velocity in Examples 8 to 11 are the same as those in Examples 2 to 4, and the catalyst used in Examples 8 to 11 is the same as the catalyst used in Examples 1 to 7.

TABLE 4

| Example | Example 8 | Example 9 | Example 10 | Example 11 |
|---|---|---|---|---|
| Methane partial | 0.025 | 0.05 | 0.075 | 0.1 |
| pressure (Mpa) | | | | |
| Composition of | (a) 25 | (a) 50 | (a) 75 | (a) 100 |
| raw material gas | vol % | vol % | vol % | vol % |
| (a) Methane | (b) 75 | (b) 50 | (b) 25 | (b) 0 |
| (b) Argon | vol % | vol % | vol % | vol % |

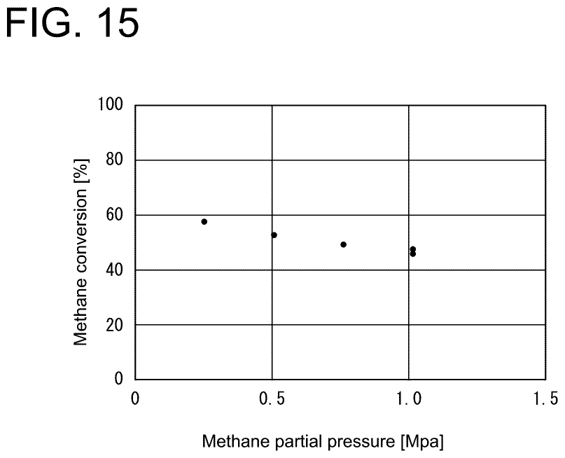

FIG. 15 shows a relationship between partial pressure of methane and peak value of methane conversion in Examples 8 to 11. FIG. 15 shows that in the methane partial pressure range between 0.025 MPa and 0.1 MPa, the peak value of methane conversion decreases slowly as the partial pressure of methane increases. However, given that the peak value of methane conversion at a methane partial pressure of 0.025 MPa is just under 60% while the peak value of methane conversion at a methane partial pressure of 0.1 MPa is just under 50%, the effect of the methane partial pressure on the peak value of methane conversion is small if the methane partial pressure is within the above-described range. Since the catalyst used in Examples 1 to 4 has been shown to maintain the activity of the direct decomposition reaction significantly longer, it is considered that the activity of the direct decomposition reaction is also maintained longer in Examples 8 to 11.

[Particle Size of Catalyst]

Next, experiments of Examples 12 to 15 were conducted using the experimental device 20 shown in FIG. 2 to examine the effect of particle size of the catalyst on the direct decomposition device 1 and direct decomposition method for hydrocarbons of the present disclosure. The experimental conditions of Examples 12 to 15 are summarized in Table 5. The catalyst amount, catalyst layer height, flow rate of raw material gas, and space velocity in Examples 12 to 15 are the same as those in Examples 2 to 4.

TABLE 5

| Example | 12 | 13 | 14 | 15 |
|---|---|---|---|---|
| Reaction | 800 | 800 | 900 | 900 |
| temperature (° C.) | | | | |
| Particle size of | 0.04~0.15 | 2~3 | 0.005~0.01 | 0.002~0.005 |
| catalyst (mm) | | | | |

| | |
|---|---|
| Composition of | Methane: 100 vol % |
| raw material gas | |

The catalyst used in Example 12 is iron powder available from Kojundo Chemical Lab. Co., Ltd., which was selected by sieving to have a particle size of 0.04 to 0.15 mm. The catalyst used in Example 13 is available from Kojundo Chemical Lab. Co., Ltd., which was selected by sieving to have a particle size of 2 to 3 mm. The catalyst in Example 14 is carbonyl iron powder available from Kojundo Chemical Lab. Co., Ltd. The catalyst in Example 15 is carbonyl iron powder available from Kojundo Chemical Lab. Co., Ltd.

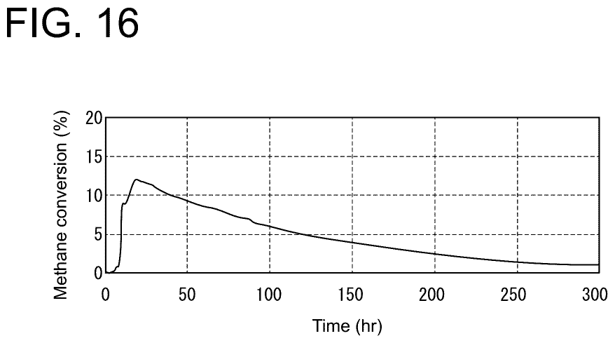

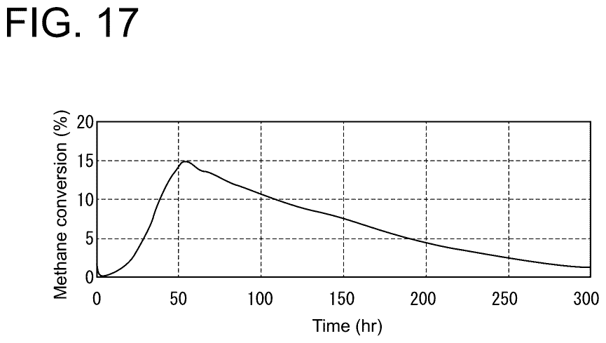

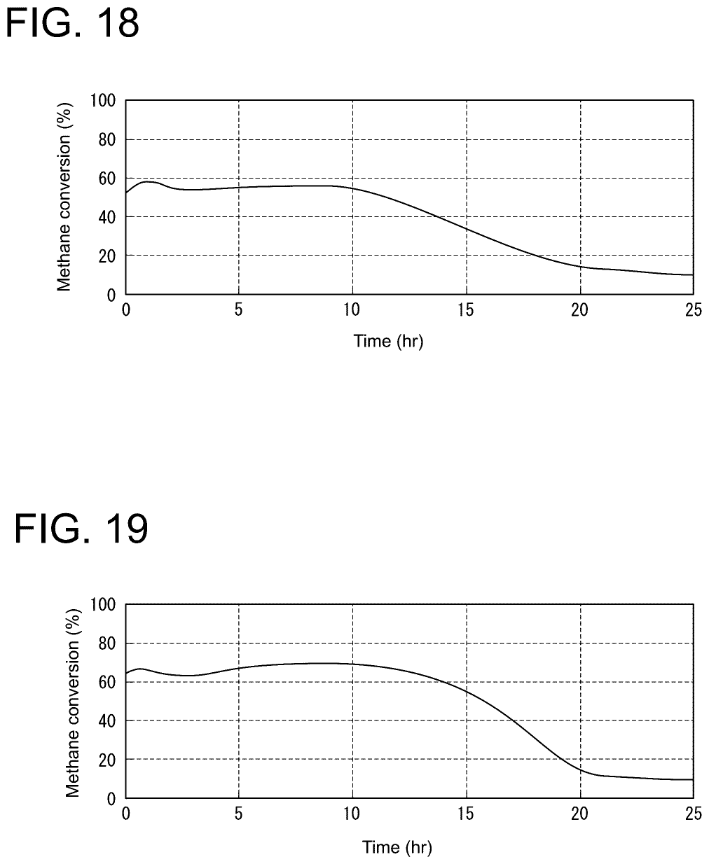

The experiment results of Examples 12 to 15 are shown in FIGS. 16 to 19, respectively. In none of Examples 12 to 15 did the maximum value of methane conversion reach almost 90% as in Example 1, but rather showed a methane conversion behavior of gradually increasing to the maximum value and then gradually decreasing, although the timing was different in each example. In Example 12, as shown in FIG. 16, the methane conversion reached its maximum value about 18 hours after the start of experiment, and in Example 13, as shown in FIG. 17, the methane conversion reached its maximum value about 51 hours after the start of experiment. Further, as shown in FIGS. 18 and 19, respectively, in Examples 14 and 15, the methane conversion reached its maximum value about 1 hour after the start of experiment.

In Example 12, the amount of hydrogen obtained during 300 hours from the start of experiment, expressed as the amount per unit catalyst amount, was 200000 (cc-hydrogen/cc-catalyst), in Example 13, the amount of hydrogen obtained during 300 hours from the start of experiment, expressed as the amount per unit catalyst amount, was 200000 (cc-hydrogen/cc-catalyst), in Example 14, the amount of hydrogen obtained during 25 hours from the start of experiment, expressed as the amount per unit catalyst amount, was 120000 (cc-hydrogen/cc-catalyst), and in Example 15, the amount of hydrogen obtained during 25 hours from the start of experiment, expressed as the amount per unit catalyst amount, was 150000 (cc-hydrogen/cc-catalyst). These results show a significant increase in the production amount of hydrogen compared to Comparative Examples 1 and 2, where the conventional supported catalyst was used, and it can thus be assumed that the above-described catalytic mechanism is also applied under the conditions of Examples 12 to 15. Further, from the experimental results of Examples 12 to 15, it can be said that when the particle size of iron particles is between 2 m and 3 mm, the specific surface area of the catalyst can be increased while maintaining the effect of developing a new active site even if carbon adheres to the catalyst, so that high activity can be maintained for a long time.

[Form of Iron Constituting Catalyst Particle]

Next, experiments of Examples 16 to 23 and Comparative Examples 3 to 5 were conducted using the experimental device 20 shown in FIG. 2 to examine the effect of form of iron on the direct decomposition device 1 and direct decomposition method for hydrocarbons of the present disclosure. The experimental conditions of Examples 16 to 23 are summarized in Table 6. The experimental conditions of Comparative Examples 3 to 5 are summarized in Table 7. The reaction temperature, catalyst amount, catalyst layer height, flow rate of raw material gas, space velocity, and composition of raw material gas in Examples 16 to 23 and Comparative Examples 3 to 5 are the same as those in Example 3.

TABLE 6

| Example | 16 | 17 | 18 | 19 | 20 | 21 | 22 | 23 |
|---|---|---|---|---|---|---|---|---|
| Iron species | Electrolytic | Electrolytic | Reduced | Reduced | Carbonyl iron | Dust in | Iron powder | Atomized |
| | iron | iron | iron | iron | powder | converter | for heat pack | powder |
| Iron purity | 99 | 99 | 99 | 86 | 99 | 94 | 98 | 99 |
| (wt%) | | | | | | | | |
| Particle size | 45 | 36 | 150 | 56 | 4 | 165 | 60 | 120 |
| (pm) | | | | | | | | |

TABLE 7

| Comparative Example | 3 | 4 | 5 |
|---|---|---|---|
| Iron species | Hematite | Magnetite | Iron powder |
| | (Fe₂O₃) | (Fe₃O₄) | |
| Iron purity | 69 | 71 | 99 |
| (wt %) | | | |
| Particle size | 1 | 1 | 100 |
| (μm) | | | |

The catalyst in Examples 16 and 17 is electrolytic iron available from Nikola Corporation, the catalyst in Example 18 is reduced iron available from Kojundo Chemical Lab. Co., Ltd., the catalyst in Example 19 is reduced iron available from DOWA IP Creation Co., Ltd., the catalyst in Example 20 is carbonyl iron powder available from Kojundo Chemical Lab. Co., Ltd., the catalyst in Example 21 is dust in converter available from Astec-irie Co., Ltd., the catalyst in Example 22 is iron powder for heat pack available from Powdertech Co., Ltd., and the catalyst in Example 23 is atomized powder available from JFE. All of the catalysts in Comparative Examples 3 to 5 are available from Kojundo Chemical Lab. Co., Ltd.

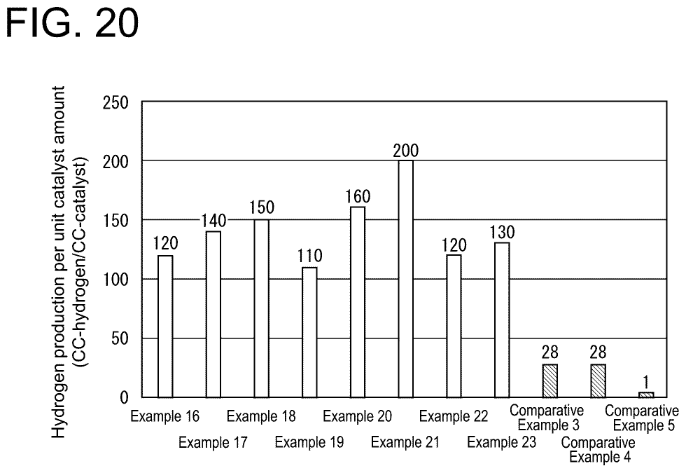

The experiment results of Examples 16 to 23 and Comparative Examples 3 to 5 are shown in FIG. 20. FIG. 20 shows the amount of hydrogen per unit catalyst amount obtained from the start of the experiment to when the methane conversion drops to 1/10 of the maximum value in Examples 16 to 23 and Comparative Examples 3 to 5. Comparative Examples 3 and 4 are iron ore, which has a smaller particle size than Examples 16 to 23, but the production amount of hydrogen was significantly lower than in the latter examples, which shows that the catalyst including a plurality of iron particles produces significantly more hydrogen than the catalyst of iron ore. Further, Examples 16 to 23 indicate that the catalyst including a plurality of iron particles, regardless of iron species, has a better effect on the production of hydrogen than the catalyst of iron ore because the production amount of hydrogen is about 4 to 7 times higher than that of iron ore, although the production amount of hydrogen varies with the iron species. Further, Examples 16 to 23 indicate that iron particles with an iron purity of 86% or more exhibit a favorable effect on the production of hydrogen.

[Crystallite Size of Iron]

As described in the explanation of the reaction mechanism using FIG. 7, the activity increases as iron particles become finer. Therefore, the iron particles that contain more grain boundaries and have lower crystallinity are more likely to be activated. Crystallinity can be evaluated by X-ray diffraction analysis, and crystallite size can be evaluated from diffraction peaks obtained by X-ray diffraction analysis.

Specifically, the X-ray diffraction peaks of the catalyst particle are obtained by X-ray diffraction analysis (JIS K 0131), and image processing including smoothing and background correction is performed for the α iron (110) peak. The crystallite size D (nm) can be obtained from the width at half maximum of the diffraction peak after removal of the Kα2 component, using the following Scherrer's equation (3). In Scherrer's equation (3), K is the Scherrer constant, λ (nm) is the wavelength of the X-ray, B (rad) is the diffraction linewidth spread, and θ (rad) is the Bragg angle.

D=Kλ/B cosθ (3)

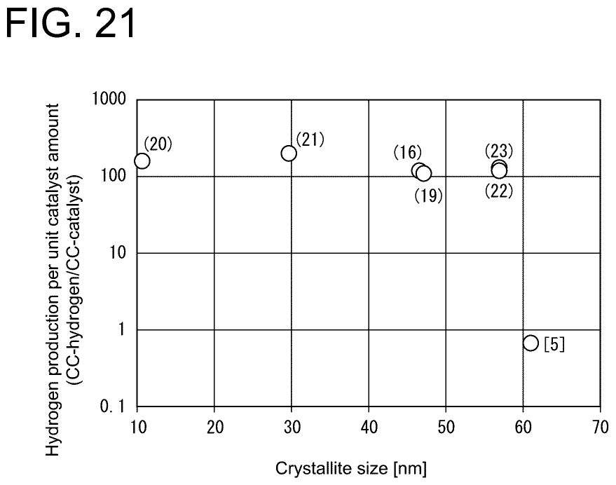

The crystallite size was determined for the catalyst particle of each of Examples 16 and 19 to 23 using the above-described method, and the relationship between crystallite size and hydrogen production is shown in FIG. 21 (the numbers in round brackets near each plot indicate the example number). FIG. 21 shows the relationship between crystallite size and hydrogen production in Comparative Example 5 as well as in Examples 16 and 19 to 23 (the plot corresponding to Comparative Example 5 is marked with [5]). In Comparative Example 5, iron powder with a particle size of 100 m was used as the catalyst particle, and experiment was conducted under the same conditions as in Examples 16 and 19 to 23 to determine the production amount of hydrogen per unit catalyst amount. FIG. 21 shows that in Examples 16 and 19 to 23, where the crystallite size is less than 60 nm, the production amount of hydrogen exceeds 100 (cc-hydrogen/cc-catalyst), whereas in Comparative Example 5, where the crystallite size exceeds 60 nm, the production amount of hydrogen drops rapidly compared to Examples 16 and 19 to 23. From these results, it can be said that if the crystallite size of iron constituting the catalyst particle is less than 60 nm, a good amount of hydrogen can be produced, i.e., the activity of the direct decomposition reaction can be maintained for a long time. Since a smaller crystallite size is preferable to maintain the activity of the direct decomposition reaction for a longer period, there is no need to set a lower limit for crystallite size. However, referring to the JIS standard for the method of measuring crystallite size of metal catalysts by X-ray diffraction method (JIS H 7805 (2005)), 2 nm, which is a general limit of measurement, may be used as a lower limit for crystallite size.

[Surface Properties of Catalyst Particle]

As described in the explanation of the reaction mechanism using FIG. 7, we considered that submicron iron particles are split from the catalyst particle and serve as the precursor of the activity. The more easily such iron particles are formed, the easier it is for the catalyst to become active in a shorter time, i.e., the faster the reaction represented by reaction formula (1) proceeds and the higher the peak value of methane conversion. Then, the effect of surface properties of catalyst particle on the direct decomposition device 1 and direct decomposition method for hydrocarbons of the present disclosure was considered. As the surface properties of catalyst particle, the specific surface area by BET method (JIS Z 8830, JIS R 1626), pore specific surface area by mercury injection method (JIS R 1655), and pore volume, which is the sum of mesopore volume measured by BET method and macropore volume measured by mercury injection method, were used. The BET method measures micropores/mesopores of 50 nm or less, while the mercury injection method measures macropores of 50 nm or more.

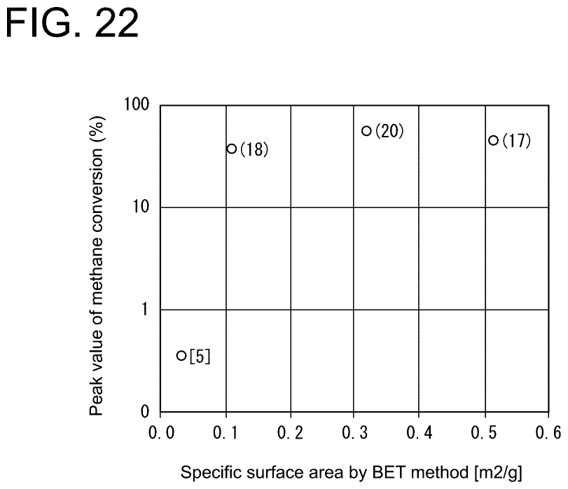

FIG. 22 shows a relationship between specific surface area by BET method and peak value of methane conversion in each of Examples 17, 18, 20 and Comparative Example 5 (the numbers in round brackets near each plot indicate the example number, the plot with [5]indicates Comparative Example 5).

FIG. 22 shows that in Examples 17, 18, and 20, where the specific surface area by BET method is 0.1 m²/g or more, the peak value of methane conversion was in the range between about 30% and 60%, whereas in Comparative Example 5, where the specific surface area by BET method is less than 0.1 m²/g, the peak value of methane conversion was extremely low, namely, less than 1%. From this result, it can be said that if the specific surface area by BET method is 0.1 m²/g or more, the effect on the peak value of methane conversion is small. Since the hydrogen production in Examples 17, 18, and 20 was found to be larger than that in Comparative Example 5, it is considered that the direct decomposition reaction proceeds faster if the specific surface area by BET method is 0.1 m²/g or more. Since a larger specific surface area by BET method is preferable to accelerate the direct decomposition reaction, there is no need to set an upper limit for specific surface area by BET method, but 10 m²/g may be set as an upper limit, which is 100 times the lower limit.

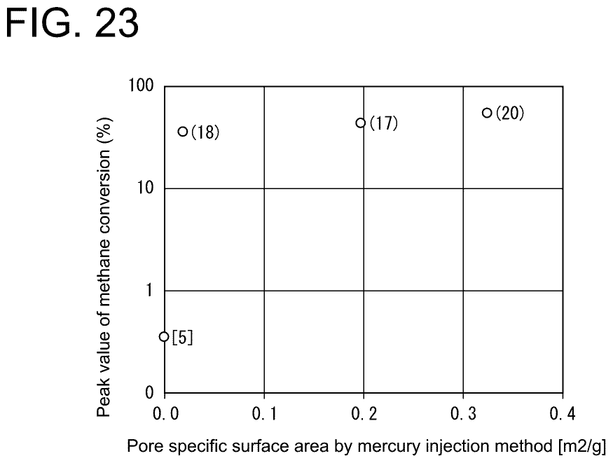

FIG. 23 shows a relationship between pore specific surface area by mercury injection method and peak value of methane conversion in each of Examples 17, 18, 20 and Comparative Example 5 (the numbers in round brackets near each plot indicate the example number, the plot with [5] indicates Comparative Example 5). FIG. 23 shows that in Examples 17, 18, and 20, where the pore specific surface area by mercury injection method is 0.01 m²/g or more, the peak value of methane conversion was in the range between about 30% and 60%, whereas in Comparative Example 5, where the pore specific surface area by mercury injection method is less than 0.01 m²/g, the peak value of methane conversion was extremely low, namely, less than 1%. From this result, it can be said that if the pore specific surface area by mercury injection method is 0.01 m²/g or more, the effect on the peak value of methane conversion is small. Since the hydrogen production in Examples 17, 18, and 20 was found to be larger than that in Comparative Example 5, it is considered that the direct decomposition reaction proceeds faster if the pore specific surface area by mercury injection method is 0.01 m²/g or more. Since a larger pore specific surface area by mercury injection method is preferable to accelerate the direct decomposition reaction, there is no need to set an upper limit for pore specific surface area by mercury injection method, but 1 m²/g may be set as an upper limit, which is 100 times the lower limit.

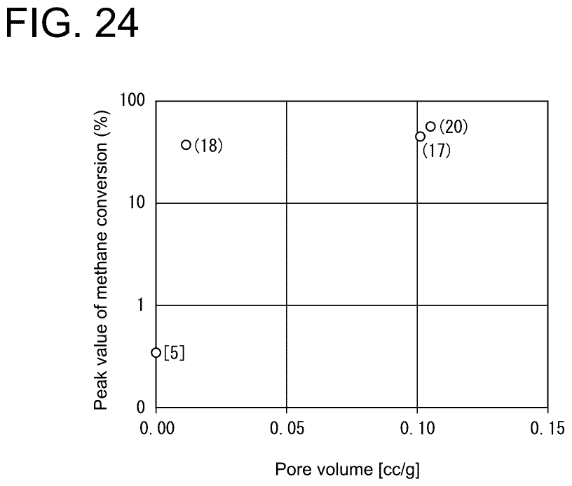

FIG. 24 shows a relationship between pore volume and peak value of methane conversion in each of Examples 17, 18, 20 and Comparative Example 5 (the numbers in round brackets near each plot indicate the example number, the plot with [5] indicates Comparative Example 5). FIG. 24 shows that in Examples 17, 18, and 20, where the pore volume is 0.01 cc/g or more, the peak value of methane conversion was in the range between about 30% and 60%, whereas in Comparative Example 5, where the pore volume is less than 0.01 cc/g, the peak value of methane conversion was extremely low, namely, less than 1%. From this result, it can be said that if the pore volume is 0.01 cc/g or more, the effect on the peak value of methane conversion is small. Since the hydrogen production in Examples 17, 18, and 20 was found to be larger than that in Comparative Example 5, it is considered that the direct decomposition reaction proceeds faster if the pore volume is 0.01 cc/g or more. Since a larger pore volume is preferable to accelerate the direct decomposition reaction, there is no need to set an upper limit for pore volume, but 1 cc/g may be set as an upper limit, which is 100 times the lower limit.

The contents described in the above embodiments would be understood as follows, for instance.

[1] A direct decomposition device for hydrocarbons according to one aspect is a direct decomposition device (1) for hydrocarbons for directly decomposing hydrocarbons into carbon and hydrogen and includes a rector (3) containing a catalyst (2) including a plurality of metal particles with an iron purity of 86% or more. The reactor (3) is configured to be supplied with a raw material gas containing hydrocarbons.

With the direct decomposition device for hydrocarbons according to the present disclosure, by using a catalyst including a plurality of metal particles with an iron purity of 86% or more as the catalyst for the reaction of direct decomposition of hydrocarbons into carbon and hydrogen, the activity of this reaction can be maintained for a long time since the activity is maintained by developing a new active site even if carbon, a product of this reaction, adheres to the catalyst.

A direct decomposition device for hydrocarbons according to another aspect is the direct decomposition device for hydrocarbons as defined in [1], where a crystallite size of iron constituting the plurality of particles is 2 nm or more and less than 60 nm.

With this configuration, the activity of the reaction of direct decomposition of hydrocarbons into carbon and hydrogen can be maintained for a long time.

A direct decomposition device for hydrocarbons according to another aspect is the direct decomposition device for hydrocarbons as defined in [1] or [2], where a specific surface area of the plurality of particles by BET method is 0.1 m²/g or more and 10 m²/g or less, or a pore specific surface area of the plurality of particles by mercury injection method is 0.01 m²/g or more and 1 m²/g or less.

With this configuration, the activity of the reaction of direct decomposition of hydrocarbons into carbon and hydrogen can be promoted to accelerate the reaction.

[4] A direct decomposition device for hydrocarbons according to still another aspect is the direct decomposition device for hydrocarbons as defined in any one of [1] to [3], where a pore volume of the plurality of particles is 0.01 cc/g or more and 1 cc/g or less.

With this configuration, the activity of the reaction of direct decomposition of hydrocarbons into carbon and hydrogen can be promoted to accelerate the reaction.

[5] A direct decomposition device for hydrocarbons according to still another aspect is the direct decomposition device for hydrocarbons as defined in any one of [1] to [4], where a particle size range of the plurality of particles is between 2 m and 3 mm.

With this configuration, the specific surface area of the catalyst can be increased while maintaining the effect of developing a new active site even if carbon adheres to the catalyst, so that high activity can be maintained for a long time.

[6] A direct decomposition device for hydrocarbons according to sill another aspect is the direct decomposition device for hydrocarbons as defined in any one of [1] to [5], where a reaction of direct decomposition of hydrocarbons into carbon and hydrogen is performed in a temperature range between 600° C. and 900° C.

With this configuration, during the reaction of direct decomposition of hydrocarbons into carbon and hydrogen, iron in the catalyst is in an austenitic state and reacts with hydrocarbons in the raw material gas to form iron carbide, which becomes the active site to develop a new active site.

[7] A direct decomposition device for hydrocarbons according to sill another aspect is the direct decomposition device for hydrocarbons as defined in any one of [1] to [6], where a partial pressure of hydrocarbons in the raw material gas is between 0.025 MPa and 0.1 MPa.

With this configuration, the activity of the direct decomposition reaction of hydrocarbons can be maintained for a long time.

[8] A direct decomposition device for hydrocarbons according to sill another aspect is the direct decomposition device for hydrocarbons as defined in any one of [1] to [7], further including a carbon removal device for removing carbon adhering to the catalyst (2) from the catalyst (2).

With this configuration, carbon adhering to the catalyst is removed from the catalyst, so that no rapid decrease in active sites occurs. Further, carbon can be easily recovered.

[9] A direct decomposition device for hydrocarbons according to still another aspect is the direct decomposition device for hydrocarbons as defined in [8], where the carbon removal device is a fluidized bed forming device (plate 12) for forming a fluidized bed of the catalyst (2) contained in the reactor (3).

When the catalyst forms a fluidized bed, the particles of the catalyst rub against each other, and carbon adhering to the catalyst is physically removed. Since a fluidized bed reactor is one of several reactor types, the adoption of such a reactor allows part of the reactor components to serve as the carbon removal device, eliminating the need for a separate carbon removal device and simplifying the configuration of the direct decomposition device for hydrocarbons.

[10] A direct decomposition device for hydrocarbons according to still another aspect is the direct decomposition device for hydrocarbons as defined in [8] or [9], where the carbon removal device includes: a catalyst regeneration device (8) for regenerating part of the catalyst (2) in the reactor (3); a catalyst supply line (9) for supplying the catalyst from the reactor (3) to the catalyst regeneration device (8); and a catalyst return line (10) for returning the catalyst (2) from the catalyst regeneration device (8) to the reactor (3).

With this configuration, carbon can be removed from the catalyst to which the produced carbon adheres to regenerate the catalyst, and at least part of the regenerated catalyst can be reused, so that the operating time of the direct decomposition device for hydrocarbons can be extended.

[11] A direct decomposition device for hydrocarbons according to still another aspect is the direct decomposition device for hydrocarbons as defined in any one of [1] to [10], further including: a reactant gas flow line (6) through which a reactant gas containing hydrogen flows after flowing out of the reactor (3); and a solid-gas separation device (7) disposed in the reactant gas flow line (6) to separate carbon from the reactant gas.

With this configuration, even if the produced carbon is entrained in the reactant gas, the carbon can be separated from the reactant gas.

[12] A direct decomposition method for hydrocarbons according to one aspect is a method for directly decomposing hydrocarbons into carbon and hydrogen and includes a step of supplying a raw material gas containing hydrocarbons to a catalyst including a plurality of metal particles with an iron purity of 86% or more.

With the direct decomposition method for hydrocarbons according to the present disclosure, by using a catalyst including a plurality of metal particles with an iron purity of 86% or more as the catalyst for the reaction of direct decomposition of hydrocarbons into carbon and hydrogen, the activity of this reaction can be maintained for a long time since the activity is maintained by developing a new active site even if carbon, a product of this reaction, adheres to the catalyst.

[13] A direct decomposition method for hydrocarbons according to another aspect is the direct decomposition method for hydrocarbons as defined in [12], further including a step of removing carbon adhering to the catalyst from the catalyst.

With this method, carbon adhering to the catalyst is removed from the catalyst, so that the carbon can be easily recovered.

### REFERENCE SIGNS LIST

1 Direct decomposition device
2 Catalyst
3 Reactor
6 Reactant gas flow line
7 Solid-liquid separation device
8 Catalyst regeneration device (Carbon removal device)
9 Catalyst supply line (Carbon removal device)
10 Catalyst return line (Carbon removal device)
12 Plate (Carbon removal device)

1. A direct decomposition device for hydrocarbons for directly decomposing hydrocarbons into carbon and hydrogen, comprising
a rector containing a catalyst including a plurality of metal particles with an iron purity of 86% or more,
wherein the reactor is configured to be supplied with a raw material gas containing hydrocarbons.

2. The direct decomposition device for hydrocarbons according to claim 1,
wherein a crystallite size of iron constituting the plurality of particles is 2 nm or more and less than 60 nm.

3. The direct decomposition device for hydrocarbons according to claim 1,
wherein a specific surface area of the plurality of particles by BET method is 0.1 m²/g or more and 10 m²/g or less, or a pore specific surface area of the plurality of particles by mercury injection method is 0.01 m²/g or more and 1 m²/g or less.

4. The direct decomposition device for hydrocarbons according to claim 1,
wherein a pore volume of the plurality of particles is 0.01 cc/g or more and 1 cc/g or less.

5. The direct decomposition device for hydrocarbons according to claim 1,
wherein a particle size range of the plurality of particles is between 2 μm and 3 mm.

6. The direct decomposition device for hydrocarbons according to claim 1,
wherein a reaction of direct decomposition of hydrocarbons into carbon and hydrogen is performed in a temperature range between 600° C. and 900° C.

7. The direct decomposition device for hydrocarbons according to claim 1,
wherein a partial pressure of hydrocarbons in the raw material gas is between 0.025 MPa and 0.1 MPa.

8. The direct decomposition device for hydrocarbons according to claim 1, further comprising a carbon removal device for removing carbon adhering to the catalyst from the catalyst.

9. The direct decomposition device for hydrocarbons according to claim 8,
wherein the carbon removal device is a fluidized bed forming device for forming a fluidized bed of the catalyst contained in the reactor.

10. The direct decomposition device for hydrocarbons according to claim 8,
wherein the carbon removal device includes:
a catalyst regeneration device for regenerating part of the catalyst in the reactor:
a catalyst supply line for supplying the catalyst from the reactor to the catalyst regeneration device; and
a catalyst return line for returning the catalyst from the catalyst regeneration device to the reactor.

11. The direct decomposition device for hydrocarbons according to claim 1, further comprising:
a reactant gas flow line through which a reactant gas containing hydrogen flows after flowing out of the reactor; and
a solid-gas separation device disposed in the reactant gas flow line to separate carbon from the reactant gas.

12. A direct decomposition method for hydrocarbons for directly decomposing hydrocarbons into carbon and hydrogen, comprising
a step of supplying a raw material gas containing hydrocarbons to a catalyst including a plurality of metal particles with an iron purity of 86% or more.

13. The direct decomposition method for hydrocarbons according to claim 12, further comprising a step of removing carbon adhering to the catalyst from the catalyst.
